(19) United States
(12) Patent Application Publication
(10) Pub. No.: US 2025/0273755 A1
(43) Pub. Date: Aug. 28, 2025

(54) Multiple Monoblock Aircraft Battery

(71) Applicant: Textron Aviation Inc., Wichita, KS (US)

(72) Inventors: Vernon Weng-Yew Chang, Wichita, KS (US); Kyle Dietz Tidball, Wichita, KS (US); Russell Allan Sharp, Wichita, KS (US); Brandon Stuart Henderson, Wichita, KS (US)

(21) Appl. No.: 19/059,480

(22) Filed: Feb. 21, 2025

Related U.S. Application Data
(60) Provisional application No. 63/556,590, filed on Feb. 22, 2024.

(51) Int. Cl. H01M 10/42; H01M 10/48; H01M 50/264; H01M 50/375; H01M 50/583

(52) U.S. Cl. CPC H01M 10/425; H01M 10/482; H01M 10/486; H01M 50/264; H01M 50/375; H01M 50/583; H01M 2010/4271; H01M 2010/4278; H01M 2220/20

(57) ABSTRACT

A battery unit for providing power to an aircraft may include one or more battery modules and a retaining structure. Each battery module comprises a monoblock and a control system coupled to the monoblock. The control system controls a switch that is actuatable to selectively engage or disengage a high power path circuit coupling the monoblock of each of the one or more battery modules to a battery power terminal connector of the battery unit. The retaining structure is configured to contain the one or more battery modules, and the retaining structure includes a monitoring system in communication with the control system of each of the one or more battery modules. The one or more battery modules are removable from the retaining structure by disconnecting at least the high power path circuit and a communication path between the control system and the monitoring system.

### CROSS-REFERENCE TO RELATED APPLICATIONS

This application claims the benefit of U.S. Provisional Patent Application No. 63/556,590, filed Feb. 22, 2024, the entire contents thereof are herein incorporated by reference.

### BACKGROUND

### 1. Field

Embodiments of the invention relate generally to battery modules, and more specifically to a multiple monoblock battery for providing power to an aircraft.

### 2. Related Art

Various solutions have been proposed for scalable battery modules that provide power and that feature safety protections from thermal events. U.S. Pat. Nos. 9,583,794 and 10,027,133 to Adrian et al. disclose a modular battery system having a plurality of battery sub-modules operably connected in parallel, and isolation and condition systems configured to isolate any one battery sub-module from the remaining battery sub-modules such that battery sub-modules can be individually added, removed, isolated and/or conditioned while other battery sub-modules continue to provide power. International Publication No. WO2018222546 and U.S. Pat. No. 10,903,464 to Huff disclose a multi-modular battery system having interchangeable individual battery modules that can be replaced and that communicate with each other using optical communication methods. Each battery module includes a plurality of cells. U.S. Patent Publication No. 2021/0203015 to Ahrens et al. discloses a modular battery device with one or more replaceable cell elements that are removable from the device without uninstalling the device or disrupting a power supply from the other cell elements in the device.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a battery unit including: one or more battery modules, each battery module including a monoblock and a control system coupled to the monoblock, the control system actuatable to selectively engage or disengage at least one first circuit coupled to the monoblock of each of the one or more battery modules; a retaining structure configured to contain the one or more battery modules and including a power connector that provides power from the one or more battery modules; a monitoring system that is in communication with the control system of each of the one or more battery modules; wherein: the at least one first circuit couples each monoblock of the one or more battery modules to the power connector and the monitoring system, each of the one or more battery modules is removable from the retaining structure by disconnecting at least the at least one first circuit and a communication path that couples the control system and the monitoring system, and the power connector provides power when the at least one first circuit of at least one of the one or more battery modules is engaged.

The embodiments described herein relate to a battery unit, further including a second circuit that couples the monoblock of each of the one or more battery modules to at least the monitoring system, and each of the one or more battery modules is removable from the retaining structure by further disconnecting a control power circuit that includes the second circuit that couples the control system of each of the one or more battery modules to the monitoring system.

The embodiments described herein relate to a battery unit, further including a second circuit that couples the monoblock of each of the one or more battery modules to at least the monitoring system, the second circuit including an aircraft signal connector that is configured to communicatively connect the monitoring system to an aircraft.

The embodiments described herein relate to a battery unit, wherein the control system is housed within an enclosure and the control system is thermally isolated from the monoblock.

The embodiments described herein relate to a battery unit, wherein the monoblock is removable from the control system.

The embodiments described herein relate to a battery unit, further including a manifold coupled to the one or more battery modules, the manifold configured to receive effluent gases produced within the monoblock of each of the one or more battery modules.

The embodiments described herein relate to a battery unit, wherein the control system of each of the one or more battery modules includes a temperature sensing device for sensing a temperature of the monoblock thereof, and the control system transmits data from the temperature sensing device to the monitoring system.

The embodiments described herein relate to a battery unit, wherein the monitoring system includes a fault management system that is in communication with the control system of each of the one or more battery modules to actuate the control system to selectively engage or disengage the at least one first circuit.

The embodiments described herein relate to a battery unit, wherein the fault management system stores data related to at least non-resettable fault events of each monoblock of the one or more battery modules retained in the retaining structure, and the monitoring system is in communication with the control system of each of the one or more battery modules to disengage the monoblock thereof having data stored in the fault management system related to a non-resettable fault event.

The embodiments described herein relate to a battery unit, further including a second circuit coupled to the monoblock of each of the one or more battery modules that includes means to test a voltage of the monoblock connected thereto.

The embodiments described herein relate to a battery unit configured to provide electrical power to an aircraft, the battery unit including: a retaining structure; a monitoring system; one or more battery modules retainable in the retaining structure, wherein each battery module includes: a monoblock including one or more battery cells, a first circuit that is coupled to the monoblock and engages at least the retaining structure and monitoring system, a second circuit that is coupled to the monoblock and engages at least the monitoring system, the second circuit including an aircraft signal connector that is configured to communicatively connect the monitoring system to the aircraft, and a control system that is actuatable to selectively engage or disengage the first circuit, wherein the control system is housed within an enclosure and is insulated from at least the monoblock of the battery module; wherein the control system of each of the one or more battery modules is in communication with the monitoring system via at least a communication path, the one or more battery modules are each removable from the retaining structure by disconnecting at least the first circuit, the second circuit, and the communication path, and the monoblock is removable from the control system.

The embodiments described herein relate to a battery unit, wherein the monoblock of each of the one or more battery modules includes a chamber configured to contain effluent gases produced by the one or more battery cells, and the battery unit further includes a manifold coupled to the chamber of each of the one or more battery modules configured to receive effluent gases contained in the chamber of each monoblock.

The embodiments described herein relate to a battery unit, wherein the control system of each of the one or more battery modules includes a temperature sensing device for sensing a temperature of the monoblock thereof, and the control system transmits data from the temperature sensing device to the monitoring system.

The embodiments described herein relate to a battery unit, wherein the monitoring system includes a fault management system that is in communication with the control system of each of the one or more battery modules to actuate the control system to selectively engage or disengage the first circuit.

The embodiments described herein relate to a battery unit configured to provide electrical power to an aircraft, the battery unit including: a retaining structure having a power connector that is configured to be electrically connected to the aircraft; a monitoring system positioned within the retaining structure; one or more battery modules retained in the retaining structure and coupled to at least the monitoring system, wherein each battery module includes: a monoblock including one or more battery cells, a high power path circuit that is coupled to the monoblock and engages the power connector and the monitoring system, a low power path circuit that is coupled to the monoblock and engages at least the monitoring system at least when the high power path circuit of the battery module is disengaged, wherein the low power path circuit is a current-limited circuit, and a control system coupled to the monoblock and communicatively connected to the monitoring system, wherein the control system controls an electronic switch that is actuatable to selectively engage or disengage the high power path circuit, and the control system is housed within an enclosure and is insulated from at least the monoblock of the battery module; wherein the power connector of the retaining structure is configured to be electrically connected to the aircraft when the high power path circuit of at least one of the one or more battery modules is engaged, and the one or more battery modules are each removable from the retaining structure by disconnecting at least the high power path circuit, the low power path circuit, and a communication path between the control system of the one or more battery modules and the monitoring system.

The embodiments described herein relate to a battery unit, wherein the monoblock is removable from the control system.

The embodiments described herein relate to a battery unit, wherein the monoblock of each of the one or more battery modules includes a chamber configured to contain effluent gases produced by the one or more battery cells, and the battery unit further includes a manifold coupled to the chamber of each of the one or more battery modules configured to receive effluent gases contained in the chamber of each monoblock.

The embodiments described herein relate to a battery unit, wherein the control system of each of the one or more battery modules includes a temperature sensing device for sensing a temperature of the monoblock thereof, and the control system transmits data from the temperature sensing device to the monitoring system.

The embodiments described herein relate to a battery unit, wherein the monitoring system includes a fault management system that is in communication with the control system of each of the one or more battery modules to actuate the control system to selectively engage or disengage the high power path circuit that electrically connects the monoblock to at least the power connector and the monitoring system.

The embodiments described herein relate to a battery unit, wherein the low power path circuit includes an aircraft signal connector that is configured to communicatively connect the monitoring system to the aircraft.

### BRIEF DESCRIPTION OF THE DRAWING FIGURES

Embodiments of the invention are described in detail below with reference to the attached drawing figures, wherein:

FIG. 1 shows a perspective view of a multiple monoblock battery unit that includes three battery modules contained in a retaining structure and a vent manifold system, in an embodiment;

FIG. 2 shows an exploded perspective view of the multiple monoblock battery unit in FIG. 1, including the three battery modules, the retaining structure, the vent manifold system, a monitoring system coupled to a terminal wall of the retaining structure, a removable panel that supports an electrical bus system, and control system enclosures that are coupled to monoblocks to form the battery modules, in an embodiment;

FIG. 3 shows an exploded perspective view of the multiple monoblock battery unit in FIG. 1 from an opposite perspective as that shown in FIG. 2, and includes the three battery modules, the retaining structure, the vent manifold system, connectors and the monitoring system expanded from the terminal wall of the retaining structure, an electrical bus system coupled to the removable panel, and straps for moving and carrying the unit, in an embodiment;

FIG. 4 shows an exploded perspective view of one of the battery modules shown in FIG. 1, the battery module including a monoblock and a control system removably coupled thereto, the control system comprising a control PCB, an SSR PCB, and a control system enclosure, in an embodiment;

FIGS. 5 and 6 show a perspective view of the multiple monoblock battery unit in FIG. 1, and includes a secondary cover, in an embodiment;

FIG. 7 shows an elevation view of the multiple monoblock battery unit in FIG. 1, and includes tie-down rods connected to lugs of the vent manifold system, the tie-down rods configured to secure the multiple monoblock battery unit to the aircraft, in an embodiment; and

FIG. 8 shows a schematic representation of one of the battery modules communicatively coupled to a monitoring system of the multiple monoblock battery unit shown in FIG. 1, in an embodiment.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

In the embodiments described herein, a battery unit 100 may be a main aircraft battery unit that may be used for at least engine starts and as an emergency power supply. The battery unit 100 provides power to the aircraft or another system and comprises one or more battery modules 110. The battery unit 100 is configured to be electrically connected to an electrical power distribution system of the aircraft that may include an aircraft bus system to direct power to one or more aircraft systems and/or other electronic systems. Each battery module 110 may be removed from or added to the battery unit 100 or replaced or exchanged with another battery module 110, such that the battery unit 100 may be scalable to be used for variety of applications and a useful lifetime of each of the components of the battery unit 100 may be maximized.

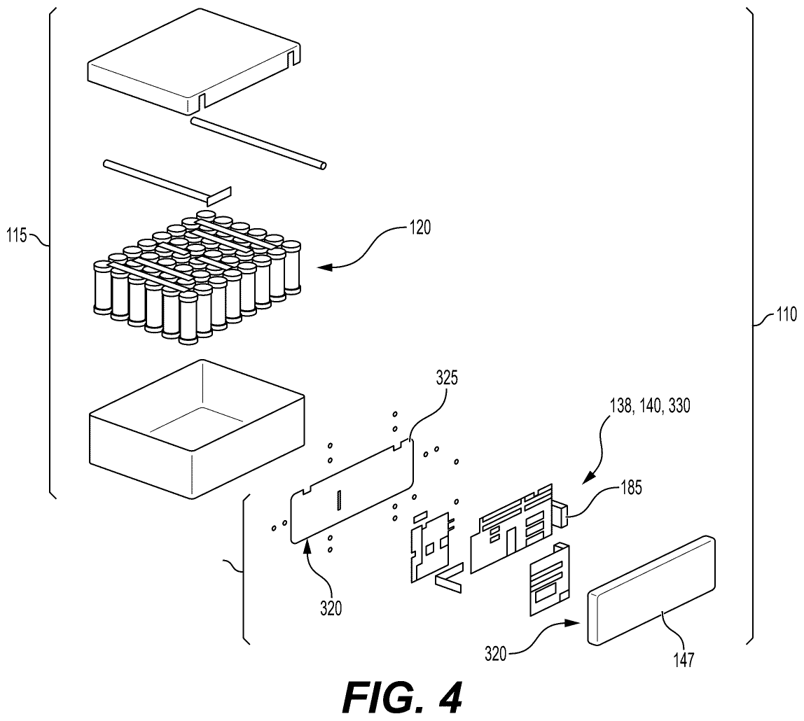

Each battery module 110 includes a monoblock 115 (as shown in FIG. 4) containing one or more battery cells 120. As used herein, the term battery module refers to a collection of cells (which may be in the form of a monoblock) coupled to electronic components, such as a control system; the term monoblock generally refers to a configuration of cells electrically coupled together to form a single (i.e., mono) block. The battery monoblocks 115 are each thermally insulated, and the monoblocks 115 are each segregated or isolated from the rest of the system, including the electronics, to prevent potential thermal events within the monoblock 115 from causing damage beyond the monoblock 115. Each monoblock 115 may be configured to vent effluent gases collected therein to the environment when a threshold pressure and/or a temperature of an interior of the battery monoblock 115 of the battery module 110 is reached or exceeded.

In an embodiment, the battery unit 100 is configured such that failure of one monoblock 115 allows for continued operation the battery unit 100, extending the lifetime of the battery unit 100, eliminating disposal of electrical components that still have a useful life, for example, the control system, and lowering costs associated with replacement of the battery unit 100. Failure of the monoblock 115 may include, for example, a thermal event, a short circuit, cell degradation, or another foreseeable issue or event.

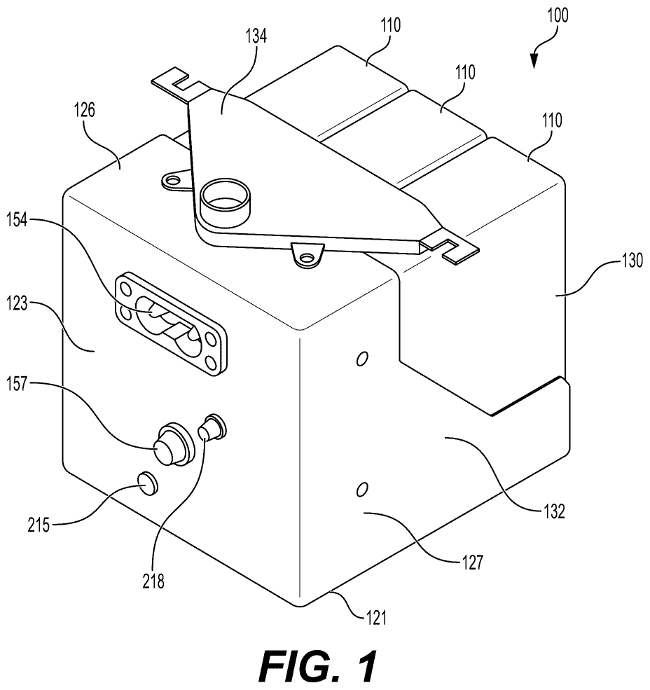

As shown in FIG. 1, the battery unit 100 comprises the one or more battery modules 110 contained in a retaining structure 121. The battery unit 100 shown in FIG. 1 includes three battery modules 110, but a battery unit 100 may include fewer or greater than three battery modules 110 without departing from the scope of the invention described herein. Each battery module 110 is removably mounted to the retaining structure 121.

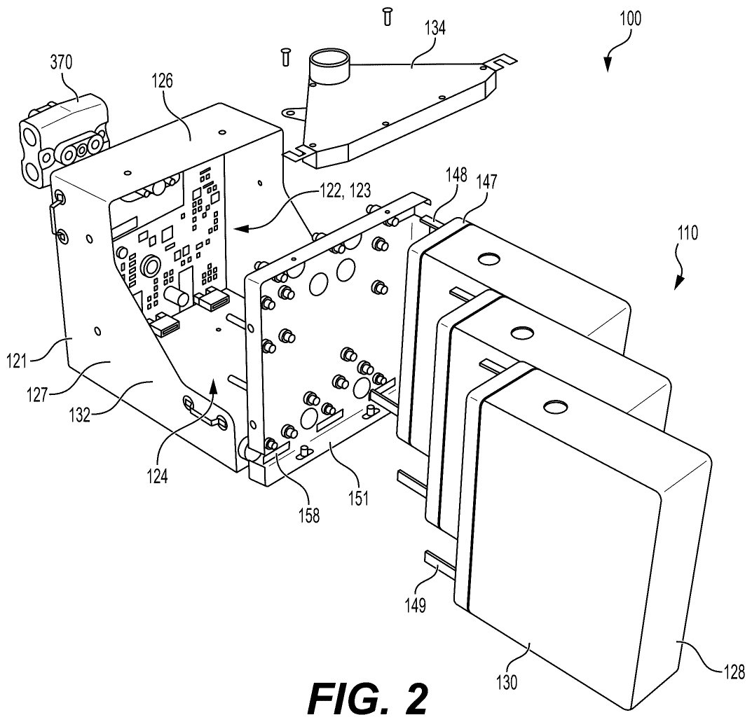

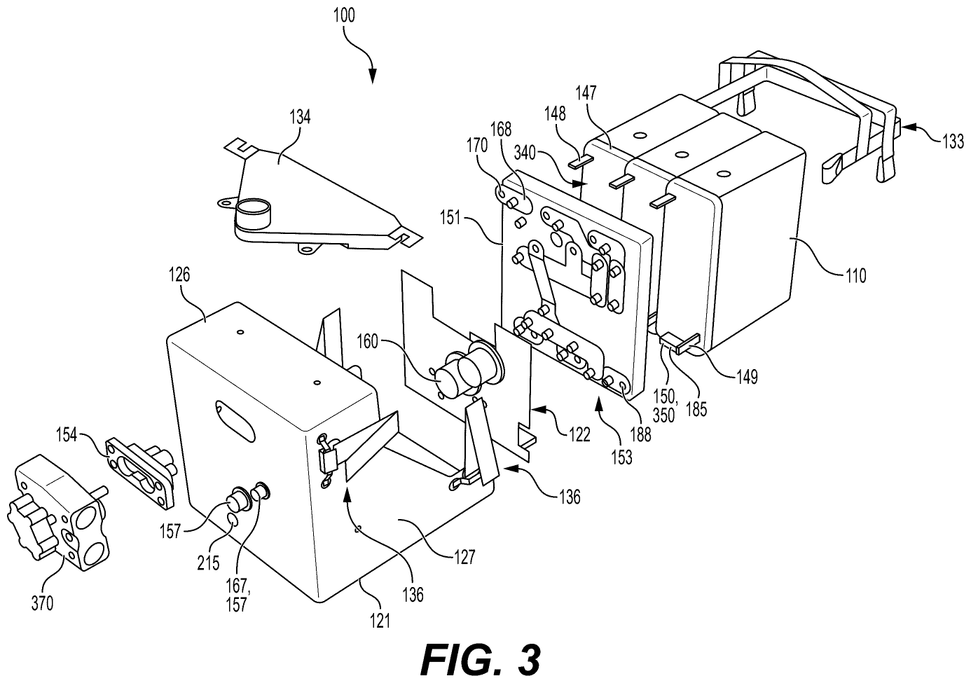

As shown in the exploded views of the battery unit 100 in FIGS. 2 and 3, when each battery module 110 is mounted in the battery unit 100, the battery module 110 is electrically connected to and in communication with a monitoring system comprising a monitoring system printed circuitry board (“monitoring system PCB”) 122 which may be adjacent to or incorporated in or coupled to an interior side of a terminal wall 123 of the retaining structure 121. It is foreseeable that the monitoring system PCB 122 is a distinct and separate system that is not coupled to the retaining structure 121. The monitoring system PCB 122 may also be referred to as a monitoring system 122. The battery module 110 being “mounted” is defined herein as the battery module 110 being physically connected to or inserted in the retaining structure 121, such as in FIG. 1, and the mounted battery module 110 may be electrically engaged or connected to the battery unit 100 or electrically disengaged or disconnected from the battery unit 100. The battery module 110 being “dismounted” is defined herein as the battery module 110 being physically disconnected or removed from the retaining structure 121 and electrically disengaged or disconnected from the battery unit 100.

FIG. 4 shows an exploded view of a battery module 110. Each battery module 110 comprises the monoblock 115 which includes the one or more battery cells 120, such as rechargeable lithium-ion battery cells or other types of cells. In one embodiment, the monoblock 115 includes an array of 48 battery cells 120, such as, for example, six groups of battery cells 120 connected in parallel, with each group including eight battery cells 120 connected in series. It is foreseeable that the number and configuration of the battery cells 120 may vary and such is within the scope of the embodiments described herein.

In one embodiment, each battery module 110 comprises battery cells 120 having the same or substantially similar chemistry as the battery cells 120 of the other battery modules 110 of the battery unit 100. The battery modules 110 of the battery unit 100 each have a similar energy capacity and/or power capacity as compared to the other battery modules 110 of the battery unit 100. It is foreseeable that an integrated bi-directional DC to DC converter, such as that disclosed in U.S. Provisional Patent Application No. 63/493,939 to Tidball et al., and incorporated herein in its entirety by reference, may be used to convert a source of direct current (DC) from one voltage level to another to allow use of battery modules having different capacities and/or different chemistries.

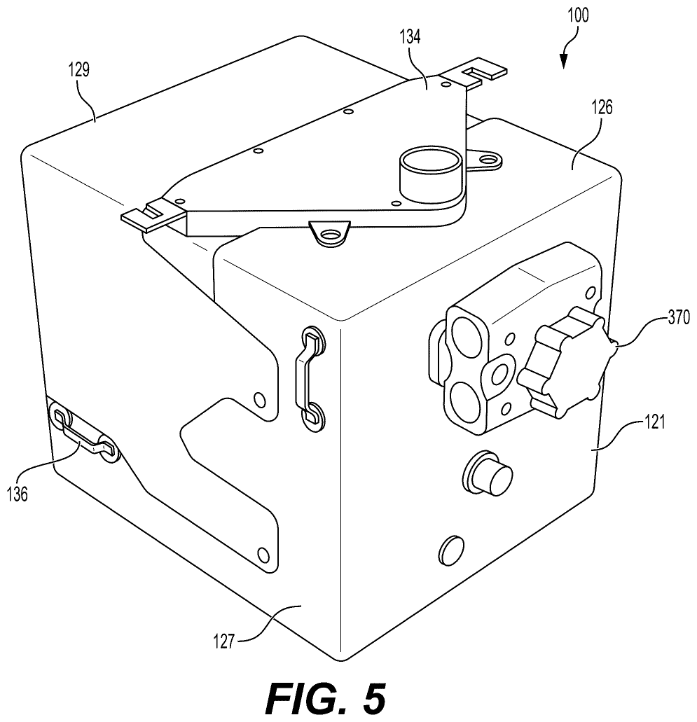

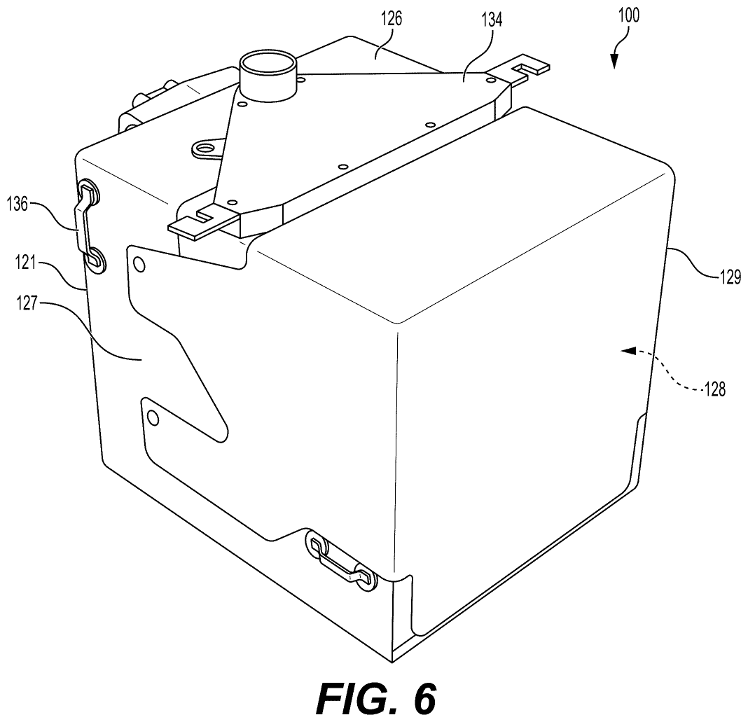

The retaining structure 121 may include a base 124 on which the battery modules 110 are positioned and wall members, including an upper wall 126 that is parallel to the base 124, side walls 127, and the terminal wall 123. In a preferred embodiment, the base 124 is formed to support the battery modules 110 that are positioned side-by-side on the base 124. In an embodiment, the base 124 may include a lip (not shown) circumventing a portion of the base 124 to contain one or more battery modules 110 in the retaining structure 121. In an embodiment, the upper wall 126 of the retaining structure 121 may include a portion that extends down (not shown) to cover rearward ends 128 of the battery modules 110 in the battery unit 100 to retain the battery modules 110 therein. The upper wall 126 extends between the side walls 127. The terminal wall 123 extends between the base 124, the upper wall 126, and the side walls 127. As shown in an embodiment in FIGS. 5 and 6, a secondary cover 129 may be installed over and/or around the battery modules 110 to restrain and contain the battery modules 110, especially during movement or vibration of the battery unit 100, and to provide additional environmental protections, such as, for example, waterproofness. The secondary cover 129 may overlap or be coupled to a portion of the retaining structure 121 and/or the rearward ends 128 of the battery modules 110.

The retaining structure 121 is formed such that an internal width of the retaining structure 121 is approximately a total width of the one or more battery modules 110 positioned therein, and the internal height of the retaining structure 121 is approximately a height of the battery modules 110. Each battery module 110 extends lengthwise in the retaining structure 121 from a removable panel 151, described herein, to the opposite end of the base 124. In one embodiment, the side walls 127 are structural members that provide support for the battery modules 110. The side walls 127 of the retaining structure 121 may or may not extend to cover at least a portion of a lateral wall 130 of the battery module 110 positioned lengthwise on the retaining structure 121. A bracket or an angled section 132 may be coupled to the side walls 127 to support the one or more battery modules 110 within the retaining structure 121. The upper wall 126 extending therebetween may have a similar width as upper ends of the side walls 127 to which it is coupled.

The retaining structure 121 removably retains or secures the one or more battery modules 110 therein and may provide a support to secure the battery unit 100 to the aircraft. In an embodiment, attachment points and/or lugs (not shown) may be coupled to the retaining structure 121 for securing the battery unit 100 to the aircraft via tie down rods (not shown) attached to the aircraft. The tie down rods secure the battery unit 100 by applying a restraining force at the attachment points and/or lugs on the retaining structure 121.

In the embodiment shown in FIG. 3, strap connectors 133 are connectable to straps and/or handles 136 coupled to the retaining structure 121 for carrying or moving the battery unit 100.

Thermal runaway is a risk related to use of battery cells 120, including lithium-ion battery cells, and a battery module 110 having a monoblock 115 that is damaged due to thermal runaway of the battery cells 120 may be required to be replaced. A thermal event may cause an increase in temperature and/or pressure in the battery monoblock 115 that may result in thermal runaway. For example, a short circuit in a battery cell 120 may generate excess heat within a battery monoblock 115 that may begin a chain of exothermic reactions that results in a rise in a temperature and/or pressure of the battery cells 120 of the battery monoblock 115.

Various methods of venting and thermally isolating each battery monoblock 115 to prevent a thermal event in one monoblock 115, or to prevent a thermal event in one monoblock 115 from effecting a thermal event in another monoblock 115 of the battery unit 100, are available. In an embodiment, a vent manifold system 134 coupled to each of the battery monoblocks 115 of the battery modules 110 is configured to allow venting of effluent gasses released from each battery monoblock 115 to the environment such that the other battery modules 110 in the battery unit 100 remain unaffected. U.S. Provisional Patent Application No. 63/496,789 to Henderson et al. (“Henderson et al.”), incorporated herein in its entirety by reference, discloses a vent manifold configured such that effluent gases produced in one or more battery monoblocks of a battery unit are discharged to the vent manifold and then from the vent manifold to the atmosphere to prevent development of heat and/or pressure that might result in propagation of thermal runaway to adjacent monoblocks and degradation or combustion of battery cells in the adjacent monoblocks. In Henderson et al., a plurality of battery cells each having a vent or pressure relief rupture disc are contained in a battery monoblock. Each monoblock includes a ventilation chamber or monoblock enclosure comprising a cell retaining structure or cell holder or a plurality of receptacles configured to receive the cells such that the vents of the cells are positioned to vent the gases within the ventilation chamber. The ventilation chamber is configured to contain gases vented by the cells within each battery monoblock and direct or release the gases in each monoblock through an opening or aperture, which may be covered by a rupture disc or an adhesive film or a one-way actuatable valve, to the vent manifold when a pressure threshold and/or temperature threshold within the monoblock is exceeded.

In an embodiment, the vent manifold system 134 is shared between the battery monoblocks 115 of the battery unit 100 and a valve or membrane (not shown), such as an independently actuatable one-way valve, extends between a ventilation chamber for each of the monoblocks 115 and the vent manifold system 134. In an embodiment, each battery monoblock 115 includes an independently actuatable valve or membrane extending into the vent manifold system 134. In an embodiment, the vent manifold system 134 includes one or more independently actuatable valves or membranes that extend into a corresponding battery monoblock 115 of the battery unit 100. The vent manifold system 134 is configured to exhaust the gases from the one or more of the battery monoblocks 115 that have undergone or are about to undergo thermal runaway through an exhaust vent to the environment or an exterior of the battery unit 100 to prevent thermal runaway from occurring in other monoblocks 115 of the battery unit 100 or contaminating the other monoblocks 115 within the battery unit 100. Each battery monoblock 115 and/or the vent manifold system 134 may also include a collection container (not shown) to prevent condensate that may collect due to a thermal runaway event from contaminating or causing damage, such as corrosion of components, to the adjacent monoblocks 115.

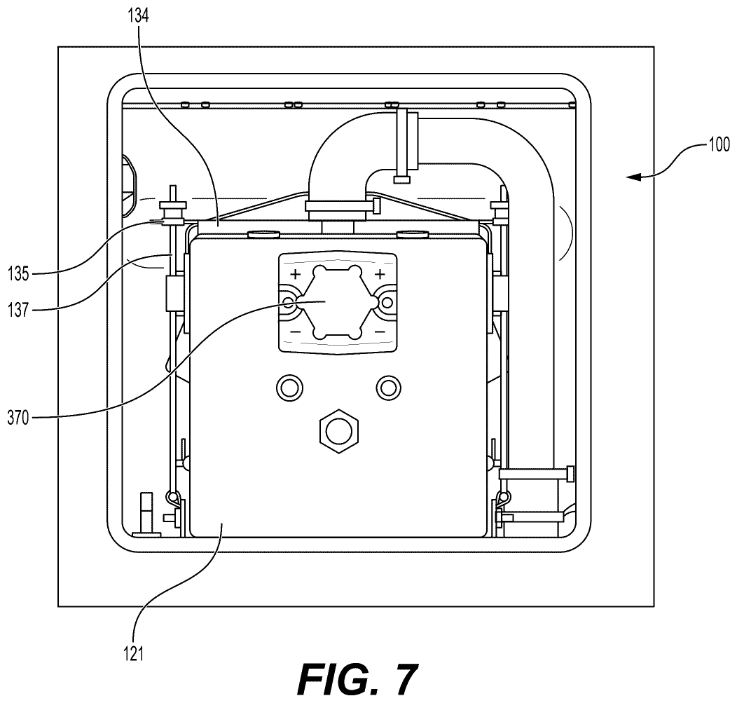

The vent manifold system 134 may also be a structural member configured to provide structural support, as shown in FIG. 7, for removably securing the one or more battery modules 110 within the chassis or retaining structure 121 and/or for securing the battery unit 100 to the aircraft. In an embodiment, the vent manifold system 134 includes lugs 135 extending therefrom that engage tie down rods 137 attached to the aircraft to restrain and prevent movement of the battery unit 100. As described herein, it is contemplated that the tie down rods 137 may be also secured to the retaining structure 121.

It is foreseeable that the battery unit 100 may not include the vent manifold system 134 or may include a manifold that is not vented. An alternate means may be used to prevent a thermal runaway event from occurring in a monoblock 115 or from advancing to an adjacent monoblock 115.

In an embodiment described herein, the battery unit 100 includes one or more battery modules 110 that may be efficiently and safely replaced, removed, or inserted, such as, for example, if a battery module 110 is faulty or inefficient and needs replacement or a thermal event has damaged the monoblock 115, or if the number of battery modules 110 in the battery unit 100 needs to be selectively reduced or increased, such as, for example, to decrease a weight of the battery unit 100 or to increase an electrical capacity provided to the aircraft systems. In an embodiment, each battery module 110 is configured to be removed and/or replaced, or is hot-swappable such that the battery module 110 may be removed and/or inserted in a process that does not include powering off the battery module 110 or the aircraft systems prior to mounting or dismounting the battery module 110 in the battery unit 100. U.S. patent application Ser. No. 18/745,643 to Tidball et al., incorporated herein in its entirety by reference, includes a battery unit having one or more battery modules that each include a battery monoblock electrically connected to a high-power path that extends through or is coupled to a solid-state relay (SSR). The high-power path provides electrical power to a powered circuitry system of the battery module and to the aircraft systems. The SSR is triggered to disengage the high-power path, disengaging the terminals of the battery module, when the battery module is dismounted from the battery unit. In addition, a low-power path provides electrical power to the powered circuitry system when the high-power path is disconnected from the powered circuitry system. The high- and low-power paths and the SSR enable at least the following: hot swappability of the battery module when dismounting from or mounting to the battery unit, activation of the low-power path to enable functionality of electronics in the battery module when the high-power path is disengaged, and prevention of potential risks associated with the high-power path terminals remaining live when the battery module is removed from the retaining structure.

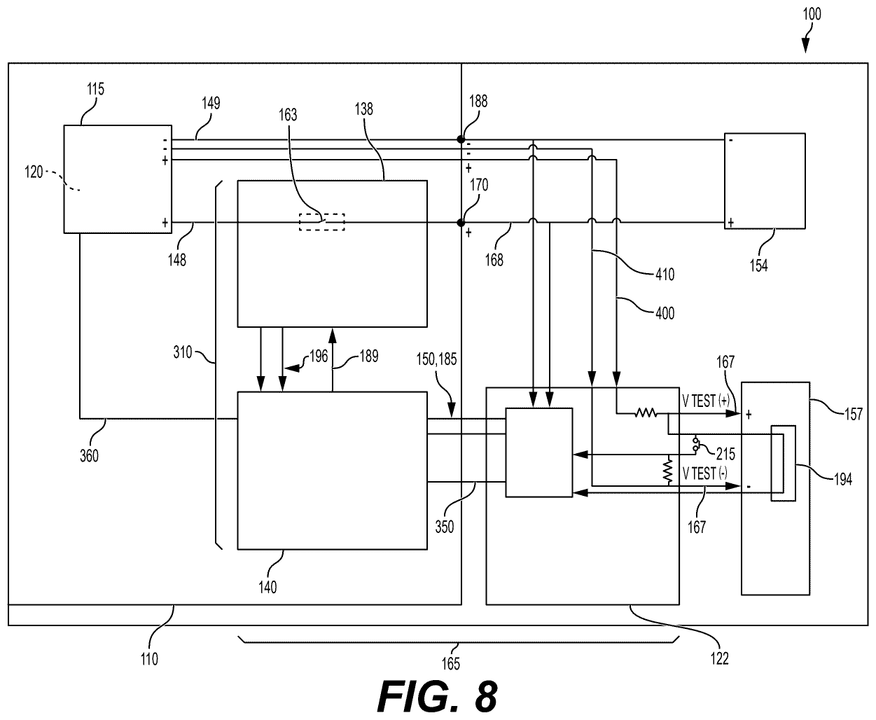

In an embodiment shown in FIG. 8, the battery module 110, which may be a hot-swap battery or not, includes a monoblock 115 containing one or more of the battery cells 120 and a control system or control electronics 310 removably coupled to the monoblock 115. The control system 310 includes a solid-state relay printed circuit board (“SSR PCB”) 138 and a control system printed circuit board (“control PCB”) 140. The SSR PCB 138 includes an electronic switch 163 configured to turn on and turn off the power being supplied to the aircraft from the battery module 110. The electronic switch 163 is actuated by the SSR PCB 138 that is controlled by the control PCB 140.

The control PCB 140 is electrically and communicatively connected between the SSR PCB 138 and the monitoring system PCB 122. As described herein, the control PCB 140 receives signals from the monitoring system PCB 122 and the monoblock 115 and transmits a control signal to control the electronic switch 163 of the SSR PCB 138 via a control circuit 189. In the embodiment shown, an electrical connection between the monoblock 115 and the electrical power distribution system of the aircraft is controlled by a monoblock powered circuitry system 165 that includes the control system 310 and the monitoring system PCB 122.

The control system 310 includes functions for monitoring, controlling, and protecting various aspects of the battery cells 120 in the monoblock 115. The control system 310 of the battery unit 100 is communicatively coupled to the monitoring system PCB 122 of the retaining structure 121 and transmits data to and from the monitoring system PCB 122 through a communication path 350. Such data may include information regarding temperature, voltage, and/or current drawn from the monoblock 115. The control system 310 is also communicably coupled to the aircraft and transmits data to and from the aircraft, or another user, through the monitoring system PCB 122 and via an aircraft signal connector 157. Such transmittals may be for diagnostics and include data or information regarding a status of each battery module 110 and/or the battery unit 100, including information regarding dismounting or disconnection of a battery module 110, a capacity of each battery module 110 and/or the battery unit 100, which battery modules 110 are available for energy transference, and the health and status of the battery modules 110 and the battery unit 100. Such communication provides information that may be used to coordinate system energy usage and facilitate power usage prioritization. Further, data from each battery module 110 may be processed by the monitoring system PCB 122, and the processed data, such as, for example, an average or representative battery temperature, number and identification of faulted modules or monoblocks, and overall battery health status, is transmitted from the monitoring system PCB 122 of the battery unit 100 to the aircraft avionics system via the aircraft signal connector 157. In one embodiment, data regarding the capacity, temperature, and/or pressure of each battery module 110 is transmitted to the aircraft avionics system via the aircraft signal connector 157.

The control system 310 comprising the SSR PCB 138 and the control PCB 140 includes a control system enclosure 320, shown in FIG. 4, which protectively and/or thermally insulates and encloses the control system 310. The control system enclosure 320 comprises a control system enclosure lid 147, a control system enclosure base 325, and various gaskets and fasteners that are configured to seal the control system 310 therein. In an embodiment, the control system 310 is removably coupled to the monoblock 115 to facilitate removal and replacement of the monoblock 115 from the battery module 110 such that the control system 310 can be coupled to a second monoblock 115 for use. In an embodiment, a snubber printed circuit board (“snubber PCB”) 330 may also be included in the control system 310 for battery module 110 protection and performance enhancement and may be coupled electrically in parallel with the SSR PCB 138. In an embodiment, the SSR PCB 138, the control PCB 140, and/or the snubber PCB 330 may be combined into a single PCB.

The control system enclosure 320 containing the control system 310 is secured to a forward end 340 of the battery module 110, such that the associated SSR PCB 138, control PCB 140, and/or snubber PCB 330 contained therein are thermally isolated and any electrolyte gases or other gases and/or liquids exiting or being vented from the associated monoblock 115 are prevented from entering the control system enclosure 320 to contaminate and/or damage the control system 310. The control system enclosure 320 comprises one or more of a combination of materials having high electrical conductivity, high environmental resistance, and resistance to corrosion from vented electrolyte gases and/or other gases that may be produced and released from the monoblock 115. As described herein, the electrolyte gases and/or other gases produced within the monoblock 115 during a thermal runaway event are released through the opening in the monoblock enclosure of the battery module 110 to the vent manifold system 134 coupled thereto, which vents the gases to the environment.

The control PCB 140 of the control system 310 is electrically coupled to a control circuit or control power path 150 and communicatively coupled to the communication path 350, both of which engage the monitoring system PCB 122 that is housed in the retaining structure 121. As shown in FIGS. 3 and 8, the control power path 150 and the communication path 350 are coupled to and extend from the control PCB 140 of the control system 310 via a connector 185 that is engageable with the monitoring system PCB 122. Each battery module 110 is removably coupled to the monitoring system PCB 122 of the retaining structure 121 via the connector 185.

Within the battery module 110, the control PCB 140 may be communicatively coupled to the battery cells 120 via a cell balancing and voltage sense path or communication path 360, which may comprise one or more of charge balancing systems for measuring and balancing or equalizing the voltages and states of charge of the battery cells 120 in the battery monoblock 115. The communication path 360 may also be used as a means of communicating a control signal between the monoblock 115 and the control PCB 140 to control the SSR PCB 138. Further, the control PCB 140 may comprise a control circuit having a current sensor 196 that transmits a voltage signal to the control PCB 140 proportional to a current through the SSR PCB 138 from a shunt (not shown) embedded within the SSR PCB 138. This information is used to monitor abnormal current conditions, such as, for example, a short circuit in either direction (into or out of the monoblock 115), and for calculating, for example, a state of charge of the monoblock 115, etc. that is communicable with the monitoring system PCB 122.

The control system 310 may comprise a temperature sensing device or a means for measuring a temperature of the associated battery module 110, such as, for example, a resistance temperature detector (RTD), a thermocouple, a negative temperature coefficient thermistor, a semiconductor-based temperature sensor, an analog device that reads an analog voltage, or another temperature sensing device known in the art. Such information may be communicated to at least the control PCB 140, and the control PCB 140 may engage one or more embedded heaters coupled to tabs or current collectors incorporated within the battery module 110. Further, such information may be communicated to the monitoring system PCB 122 for processing and/or transmittal to aircraft avionics. In an embodiment, each battery module 110 includes at least one RTD (not shown). The battery unit 100 may also include at least one RTD positioned outside of the battery modules 110 for measuring a temperature of the battery unit 100. The temperature measuring device may be directly coupled to the embedded heaters such that the embedded heaters are turned on or engaged when a first temperature is reached or turned off or disengaged when a second temperature is attained. The first temperature and the second temperature may be calculated or programmed temperatures. Data from the temperature sensing device may be used in assessing the health of each of the battery modules 110.

The control system 310 may comprise a fault management system for monitoring defined fault criteria and identifying potential failure conditions and notifying aircraft avionics via the monitoring system PCB 122 and the aircraft signal connector 157 that fault criteria thresholds have been or are approaching being met. The control system 310 may include processes or programming known in the art for rectifying potential issues. In an embodiment, the fault management system of the control system 310 rectifies potential issues by electrically disconnecting the battery module 110 from the battery unit 100. Further, the control system 310 may include passive components, such as fuses, to protect the battery module 110 against overvoltage and overload. It is foreseeable that the monitoring system PCB 122 may comprise a fault management system for monitoring fault criteria.

The battery unit 100 is arranged to enable protection of the monitoring system PCB 122 from potential thermal events. As best shown in FIG. 3, the monitoring system PCB 122 and an electrical bus system 153 are positioned between the terminal wall 123 and the partition wall or removable panel 151. In an embodiment, the electrical bus system 153 is coupled to the removable panel 151, and the removable panel 151 extends between the monitoring system PCB 122 and the battery modules 110. The removable panel 151 may provide isolation of the monitoring system PCB 122 and/or other electronics that are adjacent the terminal wall 123 from the battery modules 110. The battery modules 110 are positioned in the retaining structure 121 in engagement with the removable panel 151, and each battery module 110 electrically and/or communicatively engages the electrical bus system 153 and the monitoring system PCB 122. In an embodiment, the control system 310 of each battery module 110 is positioned to engage the monitoring system PCB 122 as described herein.

The battery modules 110 each include a high power path circuit that includes high-power paths 148 and 149 that are in engagement with the electrical bus system 153 via apertures or terminals 170 and 188, respectively, in the removable panel 151. The electric bus system 153 includes bus bars that provide an electrical junction or connection for conducting electricity from the one or more battery modules 110 to a battery power terminal connector 154 of the battery unit 100. An aircraft power connector 370 is couplable to the battery power terminal connector 154 of the battery unit 100 to enable an electrical connection of the high-power paths 148 and 149 of the battery unit 100 to the electrical power distribution system of the aircraft.

The battery modules 110 each include the connector 185 that includes the control power path 150 and the communication path 350 from the control PCB 140 of the control system 310. The connector 185 extends through an aperture 158 (see FIG. 2) in the removable panel 151 to engage the monitoring system PCB 122. In an embodiment, the control power path 150 that extends between or is coupled between the control PCB 140 and the monitoring system PCB 122 comprises the low-power paths 400 and 410, as shown in FIG. 8.

The high-power paths 148 and 149 and the low-power paths 400 and 410 of each of the monoblocks 115 of the battery unit 100 are electrically coupled to the monitoring system PCB 122 such that the monitoring system PCB 122 may be powered by one or more of the monoblocks 115. In the embodiment shown, the positive high-power path 148 is connected to a positive terminal of the monoblock 115 and is connected to the electric bus system 153 of the removable panel 151 via the terminal or connector 170. The high-power return path 149 is connected to a negative terminal of the monoblock 115 and is connected to the electrical bus system 153 via the terminal or connector 188. The electrical bus system 153 engages or is electrically connected to the monitoring system PCB 122. The positive low-power path 400 is connected to a positive terminal of the monoblock 115, and the low-power return path 410 is connected to a negative terminal of the monoblock 115. The low-power paths 400 and 410 may form the control power path 150 connected to the monitoring system PCB 122 via the connector 185.

A switch 215 (e.g., push button switch) shown in FIGS. 1 and 8 provides a means to selectively engage the low-power paths 400 and 410 for various functions, such as when the high-power paths 148 and 149 are disconnected from the powered circuitry system. The functions of the switch 215 may include, for example, engaging the control system 310 to provide a means to measure a voltage of each battery module 110; providing electrical power to the monitoring system PCB 122 and the control system 310 of a battery module 110 to enable activation of one or more embedded heaters for preheating the battery cells 120 in the monoblock 115; and providing power such that the monitoring system PCB 122 and the control system 310 are able to initiate, boot, and/or control engagement of the high-power path 148.

In an embodiment, the removable panel 151 is not required to withstand high temperatures and/or high pressures that may exist during a thermal runaway event because each monoblock 115 and the vent manifold system 134 cooperate to protect the rest of the battery unit 100 from the effects of thermal events and/or thermal runaway. In an embodiment, the removable panel 151 is a mechanical cover that functions to isolate and protect the monitoring system PCB 122 and may be formed from one or a combination of materials having a high temperature resistance to thermally insulate the monitoring system PCB 122 from high temperatures due to activity in the battery modules 110 that release heat.

The monitoring system PCB 122 is installed on or adjacent to the terminal wall 123 of retaining structure 121. As described herein with respect to the control PCB 140, the monitoring system PCB 122 is electrically coupled to the control system 310 of each battery module 110 via a control power path 150 such that the control system 310 of each battery module 110 is powered through the monitoring system PCB 122, and the monitoring system PCB 122 is communicatively coupled to the control system 310 via the communication path 350. The control power path 150 and the communication path 350 couple the control PCB 140 to the monitoring system PCB 122 via the connector 185. The monitoring system PCB 122 is electrically connected to the monoblock 115 via the high-power paths 148 and 149 and, additionally or alternatively through the low-power paths 400 and 410. In an embodiment, the monitoring system PCB 122 detects the presence or absence of a voltage from the monoblock 115 and communicates such to the control system 310. In an embodiment, communications or commands to and from the control system 310 is the presence or absence of a voltage.

The monitoring system PCB 122 may record, via the control system 310, an identification or serial number associated with each battery module 110 and/or battery monoblock 115 connected to the monitoring system PCB 122 and fault events, such as, for example, short circuit faults, associated with each serial number. Such recording is to prevent a monoblock 115 from being reused if a non-resettable fault occurs. The monitoring system PCB 122 is programmable to reject a monoblock 115 having a non-resettable fault event previously recorded by the monitoring system PCB 122. In an embodiment, the monoblock 115 is also able to store data related to fault events.

In an embodiment, the monitoring system PCB 122 includes the aircraft signal connector 157 that is connectable to the aircraft to communicate information or data or a status of the battery unit 100, including when one or more of the battery modules 110 are dismounted. One or more of the battery modules 110 may provide electrical power to the monitoring system PCB 122 via the aircraft signal connector 157 through at least the low-power paths 400 and 410 to enable the monitoring system PCB 122. As shown in FIG. 8, a connector jumper 194 of the aircraft signal connector 157 electrically connects the low-power paths 400 and 410 of a battery module 110 to the monitoring system PCB 122. The connector jumper 194 may be implemented elsewhere in the aircraft, so long as the signal is fed back to the aircraft signal connector 157.

The monitoring system PCB 122 communicates with each battery module 110 and with aircraft avionics. The monitoring system PCB 122 may include its own fault management system that is able to send commands to the control system 310 of one or more of the battery modules 110 to disconnect at least one of the monoblocks 115 from the high-power path 148. When the monitoring system PCB 122 sends disconnection commands to all battery modules, the battery unit 100 is electrically isolated from the electrical power distribution system of the aircraft, but the aircraft signal connector 157 may still be engaged to receive information from the battery unit 100.

In an embodiment of the battery unit 100, the one or more battery modules 110 comprise the high-power path 148 extending from or coupled to the positive terminal of the battery cells 120, and the high-power path 148 is coupled to the SSR PCB 138 which has an electronic switch 163. The high-power path 148 provides electrical power from the monoblock 115 via the high-power positive terminal 170 and an electrical bus system high-power path 168 to the battery power terminal connector 154 which is coupled to the aircraft power connector 370 to provide power to the electrical power distribution system of the aircraft, and to the monoblock powered circuitry system 165 when the electronic switch 163 of the SSR PCB 138 is engaged or switched “on” in response to an input voltage detected by the control system 310.

The low-power paths 400 and 410 contained within the connector 185 are part of an alternate, current-limited circuit that, in an embodiment, may extend from or be coupled to the positive and negative terminals, respectively, of the battery cells 120. The low-power paths 400 and 410 provide power to the monitoring system PCB 122 and the control system 310 when the electronic switch 163 of the SSR PCB 138 is disengaged or switched “off.” In an embodiment, the low-power paths 400 and 410 provide a limited electrical current of less than five milliamperes. In another embodiment the low-power paths 400 and 410 provide less than three milliamperes. In yet another embodiment the low-power paths 400 and 410 provide less than two milliamperes from the monoblock 115. The low-power paths 400 and 410 provide power to at least the monitoring system PCB 122 and the control system 310, and may have one or more functions, including, for example: providing a means to measure a voltage of the monoblock 115, such as, for example, by terminals or test pins 167 extending within the aircraft signal connector 157 and denoted in FIG. 8 by VTest (+) and VTest (−); to enable the one or more embedded heaters for heating the monoblock 115; and to provide power such that the monoblock powered circuitry system 165 is able to initiate, boot, and control engagement of the high-power paths 148 and 149.

When the battery module 110 is mounted on the retaining structure 121, but the monoblock 115 is electrically disengaged from the monitoring system PCB 122, the switch 215 may be selectively actuated, providing initialization power to the monitoring system PCB 122 via the low power paths 400 and 410. The monitoring system PCB 122 may, after a selected length of time, provide power to the control system 310, which in turn may actuate the electronic switch 163 of the SSR PCB 138 coupled to the high-power path 148, engaging the monoblock 115 to provide power to the aircraft and provide a primary power path to the monitoring system PCB 122 that, subsequently, powers the control system 310.

When the battery module 110 is dismounted, the connector 185, which includes the control power path 150 (i.e. the low power paths 400 and 410) and the communication path 350, extending through the aperture 158 in the removable panel 151 to engage the monitoring system PCB 122 in the retaining structure 121 is disconnected prior to the connectors 170 and 188 being disconnected, which include the high-power paths 148 and 149, respectively. Similarly, upon mounting, the connectors 170 and 188 are connected first, and the connector 185 is subsequently connected. For connector 185, this can be referred to as a last make/first break (“LMFB”) connection. The LMFB connection of connector 185 may enable the control system 310 to establish that the battery module 110 is being dismounted or mounted. In an embodiment, when the battery module 110 is dismounted, the low-power paths 400 and 410 do not provide the alternate source of electrical power through the aircraft signal connector 157 to the monoblock powered circuitry system 165, confirming that the battery module 110 has been dismounted from the retaining structure 121. In an embodiment, the control system 310 senses and determines, from the sequence of electrical disconnects of the power paths and/or whether the low-power paths 400 and 410 transmit power through the connector jumper 194 to monitoring system PCB 122, whether the battery module 110 is being dismounted or whether the battery module 110 is electrically disconnected (the electronic switch 163 coupled to the high-power path 148 is opened or disengaged) but the battery module 110 remains mounted.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A battery unit comprising:
one or more battery modules, each battery module comprising a monoblock and a control system coupled to the monoblock, the control system actuatable to selectively engage or disengage at least one first circuit coupled to the monoblock of each of the one or more battery modules;
a retaining structure configured to contain the one or more battery modules and including a power connector that provides power from the one or more battery modules;
a monitoring system that is in communication with the control system of each of the one or more battery modules; wherein:
the at least one first circuit couples each monoblock of the one or more battery modules to the power connector and the monitoring system,
each of the one or more battery modules is removable from the retaining structure by disconnecting at least the at least one first circuit and a communication path that couple the control system and the monitoring system, and
the power connector provides power when the at least one first circuit of at least one of the one or more battery modules is engaged.

2. The battery unit of claim 1, further comprising a second circuit that couples the monoblock of each of the one or more battery modules to at least the monitoring system, and each of the one or more battery modules is removable from the retaining structure by further disconnecting a control power circuit that comprises the second circuit and that couples the control system of each of the one or more battery modules to the monitoring system.

3. The battery unit of claim 1, further comprising a second circuit that couples the monoblock of each of the one or more battery modules to at least the monitoring system, the second circuit comprising an aircraft signal connector that is configured to communicatively connect the monitoring system to an aircraft.

4. The battery unit of claim 1, wherein the control system is housed within an enclosure and the control system is thermally isolated from the monoblock.

5. The battery unit of claim 1, wherein the monoblock is removable from the control system.

6. The battery unit of claim 1, further comprising a manifold coupled to the one or more battery modules, the manifold configured to receive effluent gases produced within the monoblock of each of the one or more battery modules.

7. The battery unit of claim 1, wherein the control system of each of the one or more battery modules includes a temperature sensing device for sensing a temperature of the monoblock thereof, and the control system transmits data from the temperature sensing device to the monitoring system.

8. The battery unit of claim 1, wherein the monitoring system includes a fault management system that is in communication with the control system of each of the one or more battery modules to actuate the control system to selectively engage or disengage the at least one first circuit.

9. The battery unit of claim 8, wherein the fault management system stores data related to at least non-resettable fault events of each monoblock of the one or more battery modules retained in the retaining structure, and the monitoring system is in communication with the control system of each of the one or more battery modules to disengage the monoblock thereof having data stored in the fault management system related to a non-resettable fault event.

10. The battery unit of claim 1, further comprising a second circuit coupled to the monoblock of each of the one or more battery modules that includes means to test a voltage of the monoblock connected thereto.

11. A battery unit configured to provide electrical power to an aircraft, the battery unit comprising:
a retaining structure;
a monitoring system;
one or more battery modules retainable in the retaining structure, wherein each battery module comprises:
a monoblock comprising one or more battery cells,
a first circuit that is coupled to the monoblock and engages at least the retaining structure and monitoring system,
a second circuit that is coupled to the monoblock and engages at least the monitoring system, the second circuit comprising an aircraft signal connector that is configured to communicatively connect the monitoring system to the aircraft, and
a control system that is actuatable to selectively engage or disengage the first circuit, wherein the control system is housed within an enclosure and is insulated from at least the monoblock of the battery module;
wherein the control system of each of the one or more battery modules is in communication with the monitoring system via at least a communication path, and
the one or more battery modules are each removable from the retaining structure by disconnecting at least the first circuit, the second circuit, and the communication path.

12. The battery unit of claim 11, wherein the monoblock is removable from the control system.

13. The battery unit of claim 11, wherein the monoblock of each of the one or more battery modules includes a chamber configured to contain effluent gases produced by the one or more battery cells, and the battery unit further comprises a manifold coupled to the chamber of each of the one or more battery modules configured to receive effluent gases contained in the chamber of each monoblock.

14. The battery unit of claim 11, wherein the control system of each of the one or more battery modules includes a temperature sensing device for sensing a temperature of the monoblock thereof, and the control system transmits data from the temperature sensing device to the monitoring system.

15. The battery unit of claim 11, wherein the monitoring system includes a fault management system that is in communication with the control system of each of the one or more battery modules to actuate the control system to selectively engage or disengage the first circuit.

16. A battery unit configured to provide electrical power to an aircraft, the battery unit comprising:
a retaining structure having a power connector that is configured to be electrically connected to the aircraft;
a monitoring system positioned within the retaining structure;
one or more battery modules retained in the retaining structure and coupled to at least the monitoring system, wherein each battery module comprises:
a monoblock comprising one or more battery cells,
a high power path circuit that is coupled to the monoblock and engages the power connector and the monitoring system,
a low power path circuit that is coupled to the monoblock and engages at least the monitoring system at least when the high power path circuit of the battery module is disengaged, wherein the low power path circuit is a current-limited circuit, and
a control system coupled to the monoblock and communicatively connected to the monitoring system, wherein the control system controls an electronic switch that is actuatable to selectively engage or disengage the high power path circuit, and the control system is housed within an enclosure and is insulated from at least the monoblock of the battery module;
wherein the power connector of the retaining structure is configured to be electrically connected to the aircraft when the high power path circuit of at least one of the one or more battery modules is engaged, and
the one or more battery modules are each removable from the retaining structure by disconnecting at least the high power path circuit, the low power path circuit, and a communication path between the control system of the one or more battery modules and the monitoring system.

17. The battery unit of claim 16, wherein the monoblock is removable from the control system.

18. The battery unit of claim 16, wherein the monoblock of each of the one or more battery modules includes a chamber configured to contain effluent gases produced by the one or more battery cells, and the battery unit further comprises a manifold coupled to the chamber of each of the one or more battery modules configured to receive effluent gases contained in the chamber of each monoblock.

19. The battery unit of claim 16, wherein the control system of each of the one or more battery modules includes a temperature sensing device for sensing a temperature of the monoblock thereof, and the control system transmits data from the temperature sensing device to the monitoring system.

20. The battery unit of claim 16, wherein the monitoring system includes a fault management system that is in communication with the control system of each of the one or more battery modules to actuate the control system to selectively engage or disengage the high power path circuit that electrically connects the monoblock to at least the power connector and the monitoring system.

21. The battery unit of claim 16, wherein the low power path circuit comprises an aircraft signal connector that is configured to communicatively connect the monitoring system to the aircraft.
